(19) United States
(12) Patent Application Publication
(10) Pub. No.: US 2020/0307349 A1
(43) Pub. Date: Oct. 1, 2020

(54) COAXIAL DOOR ASSEMBLY FOR HVAC

(71) Applicant: DENSO International America, Inc., Southfield, MI (US)

(72) Inventor: Brian BELANGER, Farmington Hills, MI (US)

(21) Appl. No.: 16/818,805

(22) Filed: Mar. 13, 2020

Related U.S. Application Data
(60) Provisional application No. 62/824,513, filed on Mar. 27, 2019.

(51) Int. Cl. B60H 1/00; B60S 1/54

(52) U.S. Cl. CPC B60H 1/00671; B60H 2001/00707; B60S 1/54

(57) ABSTRACT

A heating, ventilation, and air conditioning (HVAC) case for a vehicle. The HVAC case has a defrost outlet and a face outlet. A coaxial door assembly is configured to control airflow through both the defrost outlet and the face outlet. The coaxial door assembly includes an outer door and an inner door rotatable about a common axis of rotation.

### CROSS-REFERENCE TO RELATED APPLICATION

This application claims the benefit of U.S. Provisional Application No. 62/824,513 filed on Mar. 27, 2019, the entire disclosure of which is incorporated herein by reference.

### FIELD

The present disclosure relates to a coaxial door assembly for a heating, ventilation, and air conditioning (HVAC) system.

### BACKGROUND

This section provides background information related to the present disclosure, which is not necessarily prior art.

Vehicle heating, ventilation, and air conditioning (HVAC) systems typically include a case defining a plurality of airflow outlets, such as defrost outlets, demist outlets, face outlets, and foot outlets, for example. Airflow through these outlets is controlled using a plurality of airflow control doors that are actuated by a plurality of linkages. With previous HVAC systems, each one of the plurality of doors is associated with a different one of the outlets such that airflow through each outlet is controlled by a different door. Each one of the plurality of doors must be spaced apart enough to allow for independent rotation of the doors and to accommodate the associated linkages. Existing HVAC cases must therefore be quite large to accommodate the plurality of spaced apart doors and associated door linkages, which takes up valuable space within the vehicle.

### SUMMARY

This section provides a general summary of the disclosure, and is not a comprehensive disclosure of its full scope or all of its features.

The present disclosure includes a heating, ventilation, and air conditioning (HVAC) case for a vehicle. The HVAC case has a defrost outlet and a face outlet. A coaxial door assembly is configured to control airflow through both the defrost outlet and the face outlet. The coaxial door assembly includes an outer door and an inner door rotatable about a common axis of rotation.

The present disclosure also includes a heating, ventilation, and air conditioning (HVAC) case for a vehicle. The HVAC case has a defrost outlet, a face outlet, a case flange, and a coaxial door assembly. The case flange extends inward from a housing of the HVAC case between the defrost outlet and the face outlet. The coaxial door assembly is configured to control airflow through both the defrost outlet and the face outlet. The coaxial door assembly has an outer door including a first outer seal, a second outer seal, and an inner flange. The coaxial door assembly also has an inner door including a first inner seal and a second inner seal. The inner flange of the outer door extends towards the inner door. The outer door and the inner are rotatable about a common axis of rotation to a closed position, a defrost position, and a face position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an upper portion of a heating, ventilation, and air conditioning (HVAC) case in accordance with the present disclosure;

FIG. 2A is a cross-sectional view taken along line 2-2 of FIG. 1 illustrating a coaxial door assembly in a closed position in which an outer door closes the defrost outlet and an inner door closes the face outlet of the HVAC case of FIG. 1;

FIG. 2B illustrates area 2B of FIG. 2A;

FIG. 3A illustrates the coaxial door assembly of FIG. 2 in a defrost mode in which both the outer door and the inner door have been rotated to the face outlet to close the face outlet and open the defrost outlet of the HVAC case of FIG. 1;

FIG. 3B illustrates area 3B of FIG. 3A;

FIG. 4A illustrates the coaxial door assembly of FIG. 2 in a face mode in which both the outer door and the inner door have been rotated to the defrost outlet to close the defrost outlet and open the face outlet of the HVAC case of FIG. 1; and

FIG. 4B illustrates area 4B of FIG. 4A.

Corresponding reference numerals indicate corresponding parts throughout the several views of the drawings.

### DETAILED DESCRIPTION

Example embodiments will now be described more fully with reference to the accompanying drawings.

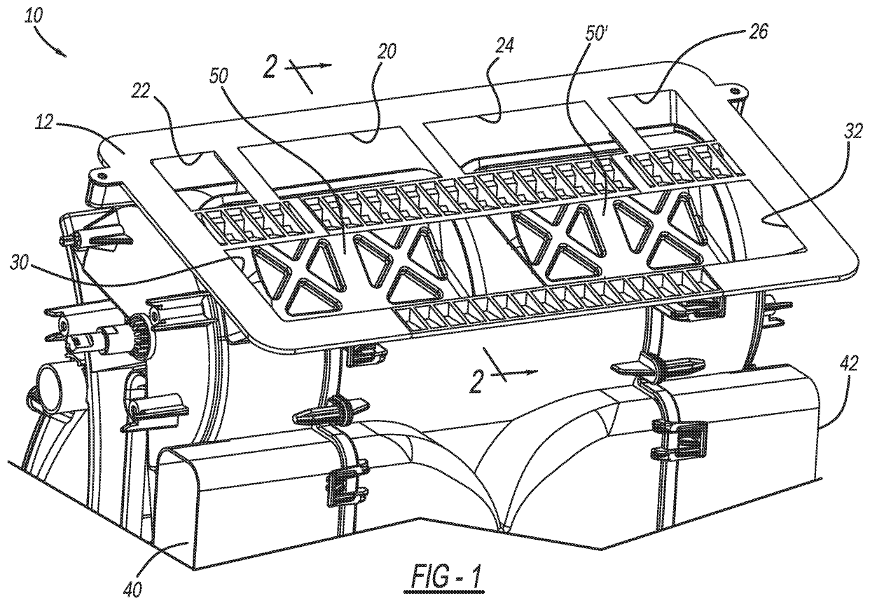

FIG. 1 illustrates an exemplary heating, ventilation, and air conditioning (HVAC) case 10 in accordance with the present disclosure. The HVAC case 10 is configured for use with any suitable vehicle HVAC system to heat airflow and direct the airflow to various locations about the vehicle, such as to a windshield, side windows, upper area of passenger cabin, lower area of passenger cabin, and rear area of passenger cabin. The HVAC case 10 may be installed in any suitable vehicle, such as any suitable passenger vehicle, mass transit vehicle, recreational vehicle, construction vehicle/equipment, military vehicle/equipment, watercraft, aircraft, etc. The HVAC case 10 may also be configured for use with any suitable non-vehicular application, such as any application calling for defrost and demist airflow to a window or any other suitable surface.

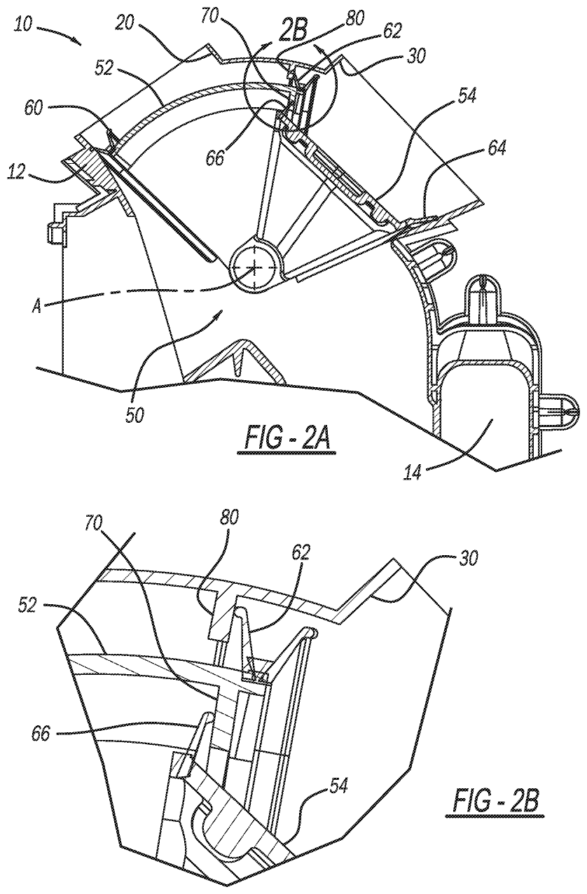

The HVAC case 10 includes a housing 12. Within the housing 12 is a heater core 14 (see FIGS. 2-4), or any other suitable device for heating airflow. The housing 12 defines a plurality of outlets through which airflow exits the HVAC case 10. Specifically, the housing 12 defines a first defrost outlet 20 and a first demist outlet 22. The first demist outlet 22 is adjacent to the first defrost outlet 20. The housing 12 may further define a second defrost outlet 24 and a second demist outlet 26, which is adjacent to the second defrost outlet 24.

The first defrost outlet 20 and the second defrost outlet 24 direct heated airflow to a windshield of the vehicle in order to defrost the windshield. The first demist outlet 22 and the second demist outlet 26 direct heated airflow to side windows of the vehicle to demist the side windows. The first and second defrost outlets 20, 24 and the first and second demist outlets 22, 26 may alternatively be configured to direct heated airflow to any other suitable surface and/or area as well.

The housing 12 further defines a first face outlet 30 and a second face outlet 32. The first and second face outlets 30, 32 direct airflow to an upper portion of the vehicle passenger cabin, such as towards the faces of occupants of the passenger cabin. Airflow exiting the first and second face outlets 30, 32 may flow directly to the passenger cabin or through any suitable tubes or other conduits leading to the passenger cabin.

The housing 12 also defines a first foot outlet 40 and a second foot outlet 42. The first and second foot outlets 40, 42 direct airflow to a lower portion of the passenger cabin, such as towards the feet of occupants of the passenger cabin. The first and second foot outlets 40, 42 are connected to any suitable airflow conduits, such as hoses, which direct the airflow to the passenger cabin. The housing 12 may further define a rear outlet through which airflow passes to a rear of the vehicle (not shown).

With continued reference to FIG. 1 and additional reference to FIGS. 2A-4B, the HVAC case 10 further includes a coaxial door assembly 50. The HVAC case 10 may include one or more coaxial door assemblies 50. For example, the HVAC case 10 may include a single coaxial door assembly 50 extending entirely across a width of the HVAC case 10 to control airflow through each one of the outlets 20, 22, 24, 26, 30 and 32. Alternatively, the HVAC case 10 may include two or more coaxial door assemblies 50 arranged side by side, and aligned along the common axis of rotation A. In the example of FIG. 1, the coaxial door assembly 50 controls airflow through each of the outlets 20, 22 and 30 as described in detail herein. Another coaxial door assembly 50′ controls airflow through the outlets 24, 26 and 32. The coaxial door assembly 50′ is substantially similar to, or identical to, the coaxial door assembly 50, and thus the description of the coaxial door assembly 50 set forth herein also applies to the coaxial door assembly 50′.

The coaxial door assembly 50 may be positioned to control airflow through the defrost outlets 20, 24, the demist outlets 22, 26, and the face outlets 30, 32. The coaxial door assembly 50 may also be positioned to control airflow through any other airflow outlets of the HVAC case 10, or any other suitable HVAC case. For example, the coaxial door assembly 50 may be positioned to control airflow through the face outlets 30, 32 and the first and second foot outlets 40, 42 of the HVAC case 10.

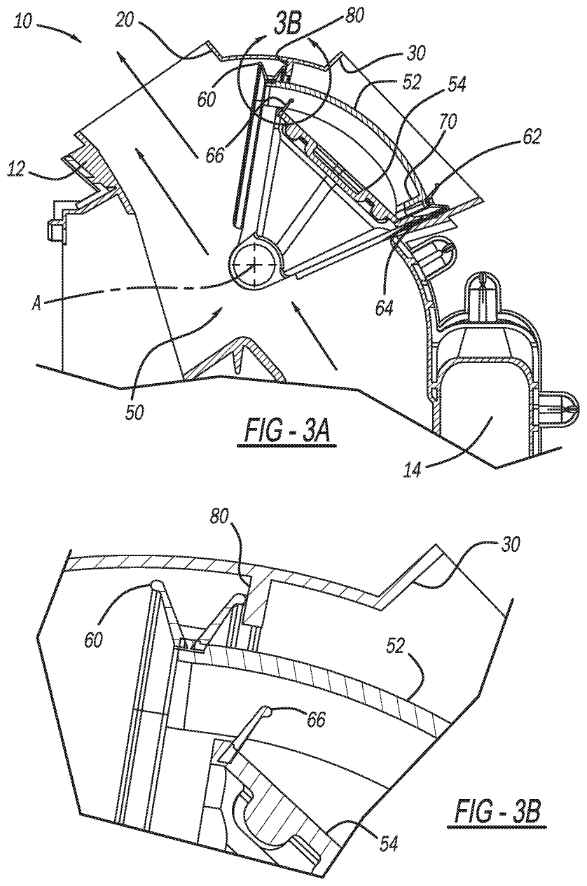

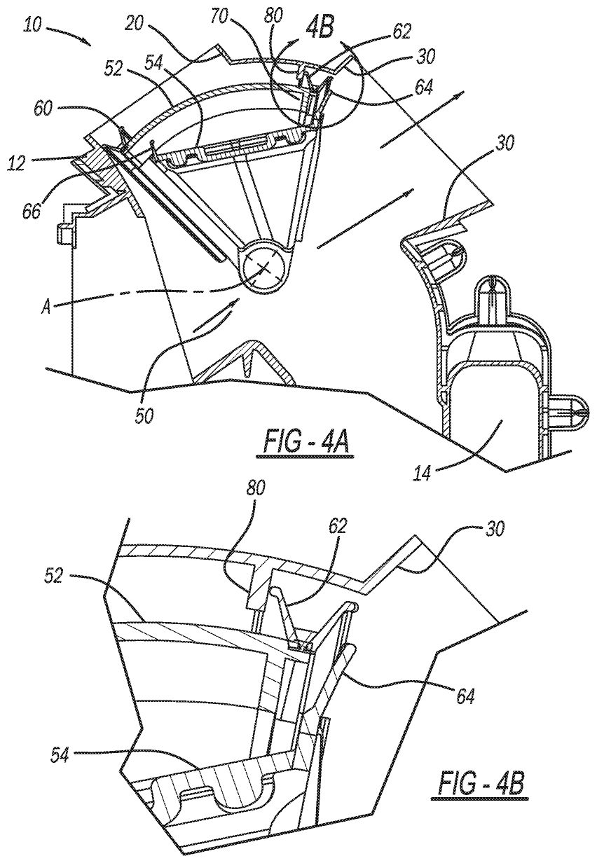

The coaxial door assembly 50 includes an outer door 52 and an inner door 54, which are rotatable about the common axis of rotation A. The outer door 52 is generally larger than the inner door 54, and thus the inner door 54 is rotatable into, or beneath, the outer door 52, as described herein and illustrated in FIGS. 3A and 4A. The outer door 52 of the coaxial door assembly 50 includes a first seal 60 and a second seal 62 at opposite ends of the outer door 52. The inner door 54 includes a first seal 64 and a second seal 66 at opposite ends of the inner door 54. Each one of the first seal 60, the second seal 62, the first seal 64, and the second seal 66 may be made of any suitable sealing material, such as any suitable elastomeric sealing material or foam sealing material.

Extending from an inner surface of the outer door 52 generally opposite to the second seal 62 is an inner flange 70. Between the first face outlet 30 and both the first defrost outlet 20 and the first demist outlet 22 is a case flange 80. Another similar case flange is between the second face outlet 32 and both the second defrost outlet 24 and the second demist outlet 26.

Operation of the coaxial door assembly 50 to control airflow will now be described in detail. The coaxial door assembly 50 is rotatable by any suitable servo or other suitable device to rotate the outer door 52 and the inner door 54 about the common axis of rotation A to the positions of FIGS. 2A-4A. The outer door 52 and the inner door 54 are rotatable to various different positions as described herein, such as a closed position, a defrost mode position, and a face mode position.

With particular reference to FIGS. 2A and 2B, the outer door 52 and the inner door 54 are rotatable to the closed position in which the outer door 52 bocks airflow through the first defrost outlet 20 and the first demist outlet 22, and the inner door 54 blocks airflow through the first face outlet 30. In the closed position of FIGS. 2A and 2B, the first seal 60 of the outer door 52 seals against an inner surface of the housing 12, and the second seal 62 seals against the case flange 80. The second seal 62 seals against a side of the case flange 80 that is opposite to the first defrost outlet 20, such that the case flange 80 is generally between the first seal 60 and the second seal 62. With respect to the inner door 54, the first seal 64 seals against the housing 12 and the second seal 66 seals against the inner flange 70 of the outer door 52. The second seal 66 seals against a side of the inner flange 70 that is generally opposite to the first seal 64 such that the inner flange 70 is between the first seal 64 and the second seal 66.

With reference to FIGS. 3A and 3B, the coaxial door assembly 50 may be configured in a defrost mode. In the defrost mode, both the outer door 52 and the inner door 54 are at the face outlet 30, and thus do not obstruct airflow through the first defrost outlet 20 or the first demist outlet 22. From the closed position of FIGS. 2A and 2B, the outer door 52 is rotated about the common axis of rotation A to the face outlet 30. Thus, in the defrost mode of FIGS. 3A and 3B, the first seal 64 of the inner door 54 and the second seal 62 of the outer door 52 seal against the housing 12 at the face outlet 30. The first seal 60 of the outer door 52 seals against the case flange 80 and specifically the side of the case flange 80 facing the first defrost outlet 20.

FIGS. 4A and 4B illustrate a face mode in which both of the outer door 52 and the inner door 54 are rotated to the first defrost outlet 20 and the first demist outlet 22 to block airflow therethrough, and permit airflow through the first face outlet 30. The first seal 60 of the outer door 52 seals against the housing 12, and the second seal 62 seals against the case flange 80 on a side thereof opposite to the first defrost outlet 20. Thus, in the face mode of FIGS. 4A and 4B, the outer door 52 is in the same closed position illustrated in FIGS. 2A and 2B. The inner door 54 is rotated into and beneath the outer door 52.

In addition to the closed, defrost, and face positions described above, the outer door 52 and the inner 54 may be arranged at any other suitable positions, such as any suitable intermediate positions. For example, the outer door 52 may be arranged partially open to allow a “bleed” to the face outlet 30, such as in a bi-level mode.

The present disclosure thus advantageously provides for one or more coaxial door assemblies 50/50′ including the outer door 52 and the inner door 54 rotatable about the common axis of rotation A to control airflow through defrost outlets 20, 24, demist outlets 22, 26, and face outlets 30, 32. The present disclosure provides for a compact, coaxial door assembly 50 that requires less space within the HVAC case 10 as compared to existing airflow control door assemblies. As a result, the HVAC case 10 can be made smaller than existing HVAC cases, which advantageously takes up less space within the vehicle. Reducing the number of airflow control doors also reduces the number of door linkages required, which advantageously reduces cost and complexity.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heating, ventilation, and air conditioning (HVAC) case for a vehicle, the HVAC case comprising:
a first airflow outlet;
a second airflow outlet; and
a coaxial door assembly configured to control airflow through both the first airflow outlet and the second airflow outlet, the coaxial door assembly including an outer door and an inner door rotatable about a common axis of rotation.

2. The HVAC case of claim 1, wherein the outer door is larger than the inner door and configured to permit the inner door to rotate within the outer door.

3. The HVAC case of claim 1, wherein the outer door includes a first seal and a second seal at opposite ends of the outer door.

4. The HVAC case of claim 3, wherein both the first seal and the second seal include an elastomeric or foam material.

5. The HVAC case of claim 1, wherein the inner door includes a first seal and a second seal at opposite ends of the inner door.

6. The HVAC case of claim 1, wherein the outer door includes an inner flange extending towards the inner door, and the inner door includes a seal configured to seal against the inner flange.

7. The HVAC case of claim 1, wherein the HVAC case includes a case flange extending towards the outer door.

8. The HVAC case of claim 1, wherein the first outlet is a defrost outlet and the second outlet is a face outlet; and
wherein in a fully closed position the outer door closes the defrost outlet and a demist outlet, and the inner door closes the face outlet.

9. The HVAC case of claim 8, wherein in the fully closed position the outer door seals against the inner door.

10. The HVAC case of claim 1, wherein the first outlet is a defrost outlet and the second outlet is a face outlet; and
wherein in a defrost mode, both the outer door and the inner door are at the face outlet with the inner door beneath the outer door to close the face outlet and permit airflow through the defrost outlet.

11. The HVAC case of claim 10, wherein in the defrost mode a first seal of the outer door seals against a case flange of the HVAC case, and a second seal of the outer door seals against a housing of the HVAC case.

12. The HVAC case of claim 1, wherein the first outlet is a defrost outlet and the second outlet is a face outlet;
wherein in a face mode both the outer door and the inner door are at the defrost outlet with the inner door beneath the outer door to close the defrost outlet and permit airflow through the defrost outlet; and
wherein in the face mode a first seal of the outer door seals against a housing of the HVAC case; and a second seal of the outer door seals against a case flange of the HVAC case.

13. The HVAC case of claim 12, wherein the first outlet is a face outlet and the second outlet is a foot outlet.

14. A heating, ventilation, and air conditioning (HVAC) case for a vehicle, the HVAC case comprising:
a defrost outlet;
a face outlet;
a case flange extending inward from a housing of the HVAC case between the defrost outlet and the face outlet; and
a coaxial door assembly configured to control airflow through both the defrost outlet and the face outlet, the coaxial door assembly including:
an outer door including a first outer seal, a second outer seal, and an inner flange;
an inner door including a first inner seal and a second inner seal, the inner flange of the outer door extends towards the inner door;
wherein the outer door and the inner door are rotatable about a common axis of rotation to a closed position, a defrost position, and a face position.

15. The HVAC case of claim 14, wherein in the closed position:
the outer door closes the defrost outlet with the first outer seal sealed against the housing and the second outer seal sealed against the case flange; and
the inner door closes the face outlet with the first inner seal sealed against the housing and the second inner seal sealed against the inner flange of the outer door.

16. The HVAC case of claim 14, wherein in the defrost position the outer door closes the face outlet with the second outer seal sealed against the housing and the first outer seal sealed against the case flange, and the inner door is within the outer door.

17. The HVAC case of claim 14, wherein in the face position the outer door closes the defrost outlet with the first outer seal sealed against the housing and the second outer seal sealed against the case flange, and the inner door is within the outer door.

18. The HVAC case of claim 14, wherein the HVAC case further comprises a demist outlet; and
wherein the coaxial door assembly is configured to control airflow through the demist outlet.

19. The HVAC case of claim 18, wherein the outer door is movable to open and close the demist outlet.
